(19) United States
(12) Patent Application Publication
(10) Pub. No.: US 2002/0063508 A1
(43) Pub. Date: May 30, 2002

(54) Picture display device with reduced deflection power

(75) Inventors: Marteijn De Jong, Eindhoven (NL); Marcellinus Petrus Carolus Michael Krijn, Eindhoven (NL); Pim Theo Tuyls, Eindhoven (NL); Boris Skoric, Eindhoven (NL); Michel Cornelis Josephus Marie Vissenberg, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONIC N.V.

(21) Appl. No.: 09/995,440

(22) Filed: Nov. 27, 2001

(30) Foreign Application Priority Data
Nov. 29, 2000 (EP) 00204239.8

(51) Int. Cl. H01J 29/70

(52) U.S. Cl. 313/440

(57) ABSTRACT

A picture display device comprising a cathode ray tube (1) with an elongated display screen (8) and a deflection system (9) is described. The deflection power is reduced by two means. The deflection system (9) is arranged to scan the lines in the direction of the short axis (22) of the display screen (8), and the cone portion (3) of the cathode ray tube (1) has an elongated cross-section (54) whose aspect ratio is larger than or equal to the aspect ratio of the display screen (8), thereby enabling the deflection system (9), and in particular the line deflection subsystem (12), to be positioned closer to the electron beam envelope (51), which reduces magnetic losses.

### BACKGROUND OF THE INVENTION

The invention relates to a picture display device comprising:

a cathode ray tube having an elongated display screen with a long axis and a short axis, a cone portion whose cross-section has an elongated shape with a long axis and a short axis, a neck comprising means for generating at least one electron beam, and

a deflection system mounted on said cone portion for generating electromagnetic fields for deflecting said electron beam(s).

A picture display device as described above is known from U.S. Pat. No. 5,962,964. The CRT of said known display device comprises a cone portion whose cross-section varies gradually from a circular shape at the neck end of the cone portion to a rectangular shape at the display screen end of the cone portion.

At the reference deflection plane—which is the plane perpendicular to the cathode ray tube axis and going through the point of intersection between the cathode ray tube axis and the asymptote to the trajectory of the electron beam when deflected to a corner of the display screen—the cone portion of said known display device has a cross-section which has a substantially rectangular shape. The deflection system can therefore be positioned closer to the envelope of the electron beam(s) than within CRTs whose cones have circular cross-sections. Magnetic losses are thereby reduced and, as a result, less deflection power is needed.

According to U.S. Pat. No. 5,962,964, deflection power consumption reductions between 17% and 25% can be achieved.

Nevertheless, there is a wish to further reduce the power consumption of the deflection system.

### SUMMARY OF THE INVENTION

It is an object of the invention to provide a picture display device with which a further reduction of the deflection power is achieved.

In accordance with an aspect of the invention, the picture display device is therefore characterized in that the deflection system is arranged to scan the electron beam(s) along lines substantially parallel to the short axis of the display screen, and in that the part of the cone portion which is under the deflection system has at least one cross-section whose internal outline has a long axis/short axis ratio (A_{c}) which is larger than or equal to the long axis/short axis ratio (A_{scr}) of the display screen.

The present invention allows a further reduction of deflection power of about 30% as compared with the cited prior art. This reduction is essentially achieved by reducing the line deflection power, which is the major consumer in the deflection system.

The line deflection power is reduced by reducing the sweep amplitude, which is achieved by scanning the lines substantially parallel to the short axis of the display screen (called transposed scan) instead of parallel to the long axis of the display screen (called normal scan) and the line deflection power is further reduced by reducing magnetic losses, which is achieved by bringing the line deflection system closer to the electron beam envelope, while paying particular attention to the aspect ratio of the latter.

The inventors have realised that, with transposed scanning, the aspect ratio of the cross-section of the electron beam envelope (Aₑₗ) in parts of the region under the deflection system is larger than or equal to A_{scr}, in contrast to normal scanning.

Based on this insight, the picture display device in accordance with the invention comprises a cone portion whose cross-section in parts of the region under the deflection system has an aspect ratio (A_{c}) which is also larger than or equal to A_{scr}.

In preferred embodiments, Aₑₗ exceeds A_{scr} in parts of the region under the deflection system to the extent that (Aₑₗ−1)/(A_{scr}−1)≧1.1, and therefore it is advantageous that A_{c} also exceeds A_{scr} to the extent that (A_{c}−1)/(A_{scr}−1)≧1.1 in parts of that region.

In the region between the reference deflection plane and that end of the deflection system nearest to the display screen—which is the region where most of the magnetic field is concentrated—it is also advantageous that the cross-section of the cone has a shape which follows the shape of the electron beam envelope as closely as possible. Therefore, it is advantageous that, in this region, A_{c} first increases, goes through a maximum and then decreases.

Furthermore, the reduction of deflection power grows with growing screen aspect ratios. The invention is thus particularly effective for picture display devices with large screen aspect ratios. In particular, the invention is advantageous for picture display devices with A_{scr}>4/3, and a fortiori for picture display devices with A_{scr}≧16/9.

The economy of deflection power may be used advantageously to increase the maximum deflection angle of the electron beam(s). In preferred embodiments, maximum deflection angles larger than or equal to 120° are realised. This is useful in building slimmer CRTs.

### BRIEF DESCRIPTION OF THE DRAWINGS

These and further aspects of the invention will be explained in greater detail by way of example and with reference to the accompanying drawings, in which:

FIG. 1 is a sectional view of a picture display device according to an embodiment of the invention;

FIG. 2 is a sectional view of the display window;

FIGS. 3a and 3b are schematic representations of a cross-section of a picture display device under the deflection system according to the prior art and according to an embodiment of the present invention, respectively, showing the principle of normal scanning versus transposed scanning;

FIG. 4a is a cross-section of the electron beam envelope in the region under the deflection system;

FIG. 4b is a graph showing the values of the aspect ratio of the electron beam envelope along the z-axis for a CRT with normal scanning and with transposed scanning;

FIGS. 5a and 5b are schematic representations of a cross-section of a picture display device under the deflection system, showing the difference in cone aspect ratios; and

FIG. 6 is a graph showing the values of the aspect ratio of the electron beam envelope along the z-axis for a CRT with transposed scanning for various screen aspect ratios and for various maximum deflection angles.

The Figures are not drawn to scale. In general, like reference numerals refer to like parts.

### DETAILED DESCRIPTION OF PREFERRED EMBODIMENTS

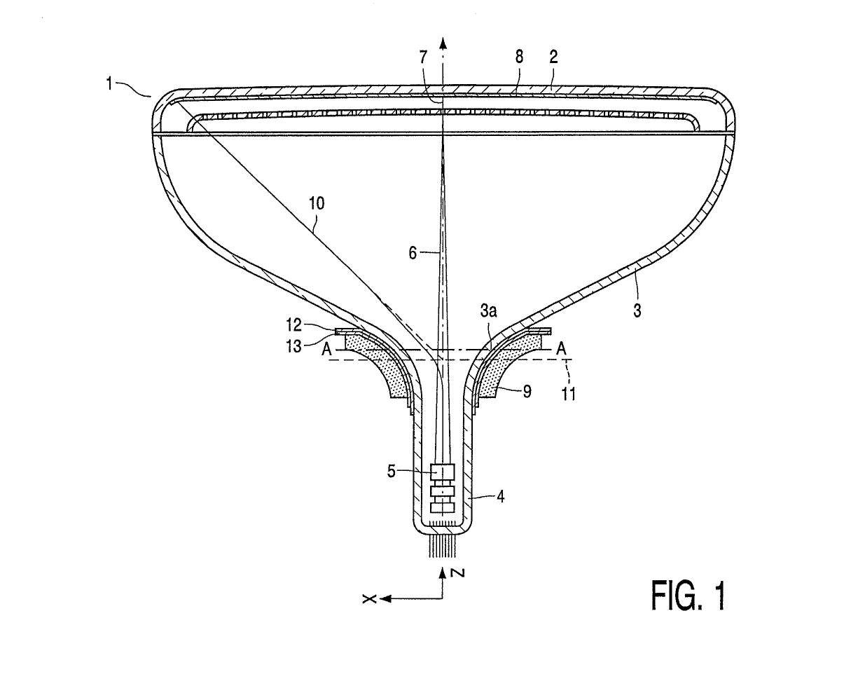

A picture display device according to a preferred embodiment of the invention is shown in FIG. 1.

It comprises a cathode ray tube (1), which includes a display window (2), a cone portion (3), and a neck (4). The neck (4) accommodates a means (5) for generating at least one electron beam (6). In this embodiment, three electron beams are generated in one plane (the in-line plane). The inner surface of the display window (2) comprises a large number of phosphor elements which form a display screen (8). When the electron beam (6) hits a phosphor element, the latter becomes phosphorescent, thereby creating a visible spot on the display screen (8). In the undeflected state, the electron beam (6) substantially coincides with the tube axis (7). On its way to the display screen (8), the electron beam (6) is deflected by means of a deflection system (9) covering a part (3a) of the cone portion (3). Said deflection system (9) comprises a line deflection subsystem (12) and a frame deflection subsystem (13), in order to create a two-dimensional picture on the display screen (8). In this embodiment, the deflection system (9) is made up of sets of coils, one set for the line deflection subsystem (12) and another set for the frame deflection subsystem (13).

FIG. 1 also shows the reference deflection plane (11) which is a plane perpendicular to the tube axis (7) and going through the point of intersection between the tube axis (7) and the asymptote to the trajectory (10) of the electron beam when deflected to a corner of the display screen (8).

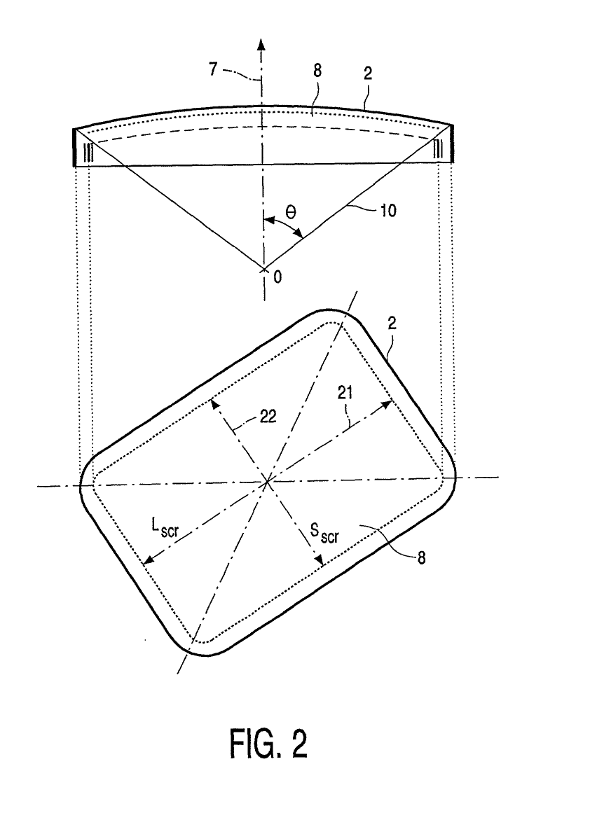

As can be seen from FIG. 2, the display screen (8) has an elongated shape with two perpendicular axes of symmetry: a long axis (21) having a length of L_{scr} and a short axis (22) having a length of S_{scr}. In order to quantify the amount of elongation of the display screen (8), the aspect ratio of the display screen (8) is defined as A_{scr}=L_{scr}/S_{scr}.

The maximum deflection angle is also defined as the angle θ between the tube axis (7) and the deflected electron beam (10) when the electron beam is deflected so as to hit a point on the display screen (8) which is furthest away from the intersection between the tube axis (7) and the display screen (8).

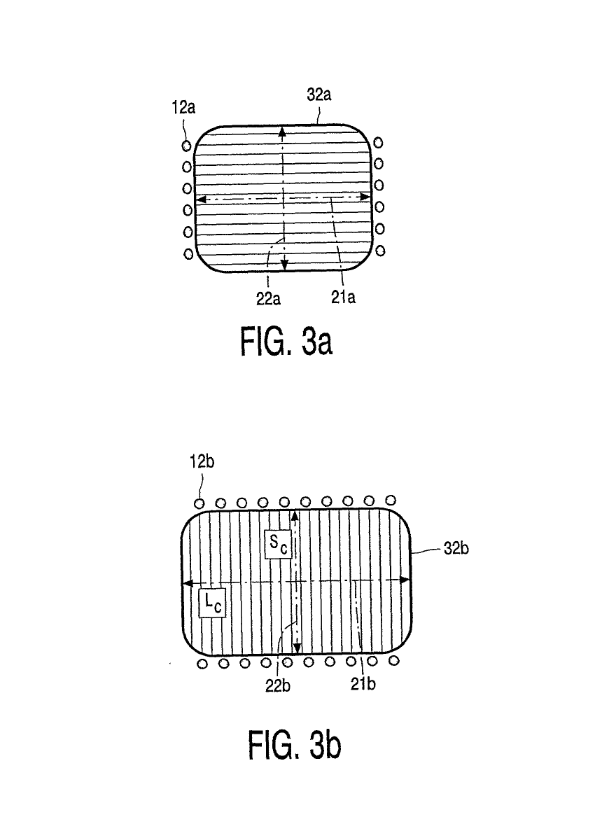

FIGS. 3a and 3b schematically show a cross-section of a picture display device in a region (3a) where the cone portion (3) is under the deflection system (9) according to the prior art (FIG. 3a) and according to an embodiment of the present invention (FIG. 3b), respectively. As can be seen in these Figures, a cross-section (32a,b) of the cone portion under the deflection system (9) has an elongated shape with two perpendicular axes of symmetry: a long axis (21a,b) having a length of L_{c} and a short axis (22a,b) having a length of S_{c}. In order to quantify the amount of elongation of the cross-section of a cone portion, the aspect ratio of the cross-section of a cone portion is defined as A_{c}=L_{c}/S_{c}.

In the prior art (FIG. 3a), the line deflection subsystem (12a) deflects the electron beam (6) so as to scan the display screen (8) along lines substantially parallel to the long axis (21a) of the display screen (called normal scan).

According to the invention (FIG. 3b), the line deflection subsystem (12b) deflects the electron beam so as to scan the display screen (8) along lines substantially parallel to the short axis (22b) of the display screen (called transposed scan), and a cross-section (32b) of the cone portion under the deflection system (9) has an aspect ratio AC which is larger than the aspect ratio of the display screen (A_{scr}).

With transposed scan, the line deflection power can be reduced by virtue of the reduced sweep amplitude.

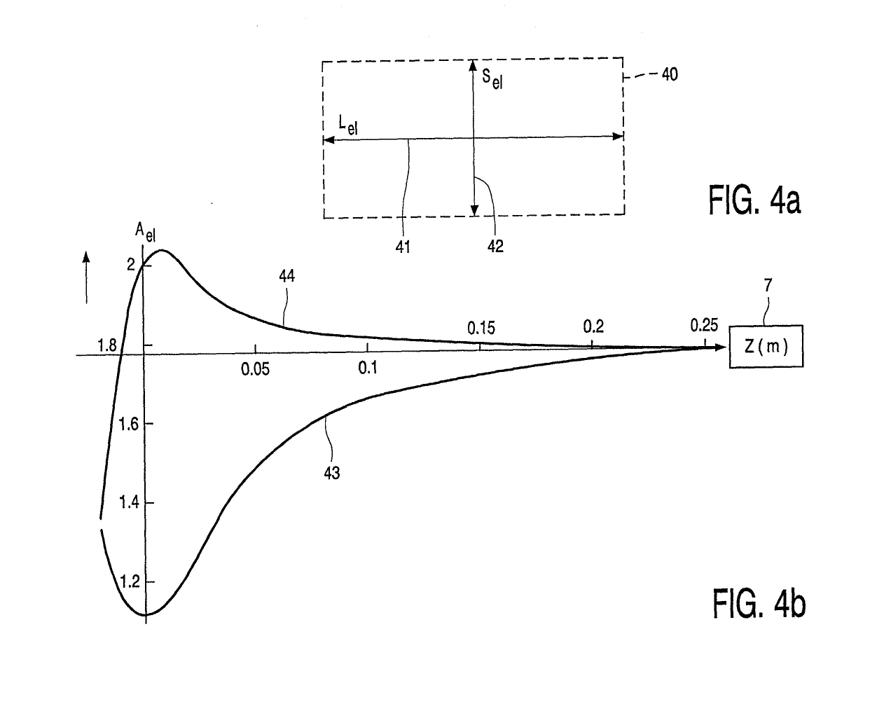

The inventors have also realized that, with transposed scan, the electron beam envelope in part of the region under the deflection system (9) has a particular shape. As can be seen in FIG. 4a, a cross-section (40) of the electron beam envelope in said region has an elongated shape with a long axis (41) having a length of Lₑₗ and a short axis (42) having a length of Sₑₗ. In order to quantify the amount of elongation, the aspect ratio of a cross-section of the electron beam envelope is defined as Aₑₗ=Lₑₗ/Sₑₗ.

FIG. 4b is a graph showing a curve with values of Aₑₗ along the tube axis Z (7) for a display screen (8) with an aspect ratio A_{scr}=16/9, both for normal scan (curve 43) and for transposed scan (curve 44).

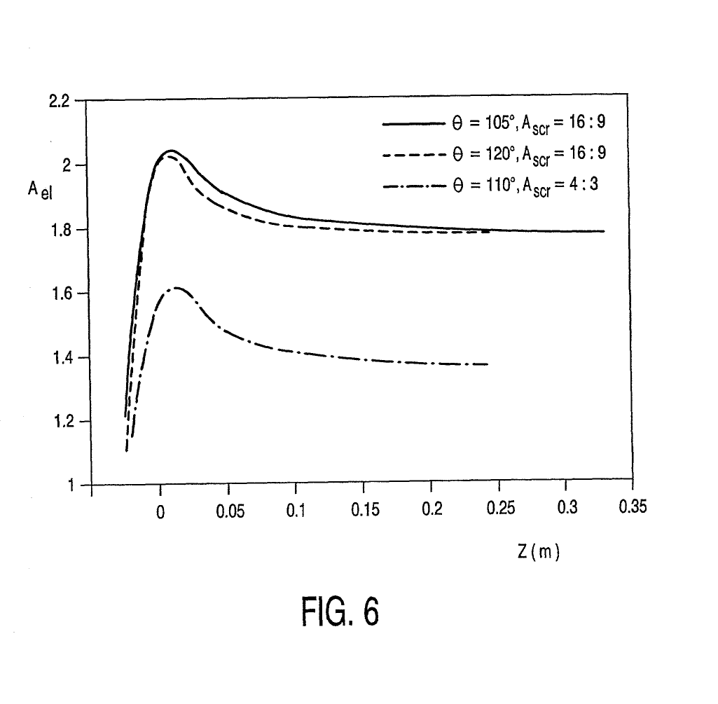

In the region under the deflection system (z=−0.03 to z=+0.04), the value of Aₑₗ for transposed scan grows quickly towards the value of A_{scr}, and even exceeds it, in contrast to normal scan. This characteristic feature holds for various screen aspect ratios (ex. 4/3 and 16/9) and for various maximum deflection angles (ex. 105°, 110° and 120°), as can be seen from FIG. 6.

Based on this insight, a picture display device according to the present invention comprises a cone portion in part of the region under the deflection system (9) whose cross-section has an aspect ratio (A_{c}) which is also larger than or equal to A_{scr}.

This allows bringing the deflection system (9), and in particular the line deflection subsystem (12), much closer to the electron beam envelope, thereby reducing magnetic losses and consequently reducing the deflection power.

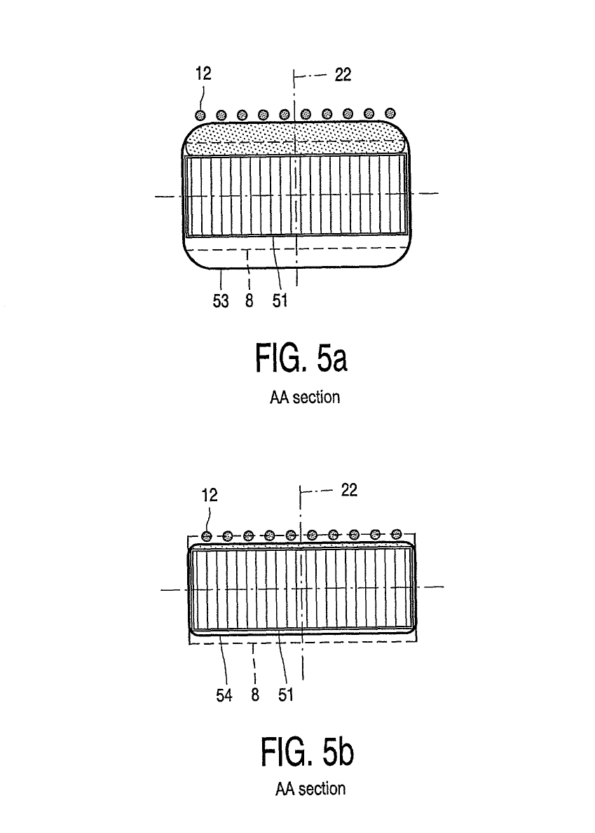

Such an effect is illustrated in FIG. 5a and FIG. 5b. Both Figures schematically show a cross-section of a picture display device in part of the region (3a) under the deflection system (9). FIG. 5a shows a cone cross-section (53) with an aspect ratio A_{c} which is smaller than the aspect ratio A_{scr} of the display screen (8), whereas FIG. 5b shows a cone cross-section (54) with an aspect ratio A_{c} which is larger than the aspect ratio A_{scr} of the display screen (8), thereby enabling the line deflection subsystem (12) to be positioned closer to the electron beam envelope (51).

The aspect ratio A_{c} of known picture display devices varies gradually from 1 to A_{scr}, without ever getting equal to, or neither exceeding A_{scr}. Typical examples are given in U.S. Pat. No. 5,962,964 for a 4:3 screen (A_{scr}=1.333), wherein A_{c}=1.2 at the reference deflection plane (11).

In preferred embodiments according to the present invention, Aₑₗ exceeds A_{scr} to the extent that (Aₑₗ−1)/(A_{scr}−1)≧1.1 in part of the region under the deflection system (9), and therefore it is advantageous that A_{c} also exceeds A_{scr} to the extent that (A_{c}−1)/(A_{scr}−1)≧1.1 in that region.

It is also advantageous that, in the region between the reference deflection plane (11) and that end of the deflection system (9) nearest to the display screen (8)—which is the region where most of the magnetic field is concentrated—the cross-section of the cone has a shape which follows the shape of the electron beam envelope as closely as possible. Therefore, it is advantageous that, in this region, A_{c} first increases, goes through a maximum and then decreases.

Moreover, the power reduction effect increases with growing screen aspect ratios, so that the present invention is particularly attractive for new type picture display devices with large screen aspect ratios such as A_{scr}>4/3, and a fortiori for A_{scr}≧16/9.

Overall, a picture display device according to the present invention can reduce the deflection power by about 30% as compared with the prior art.

A further merit of the invention is that the reduction of deflection power can be used advantageously to increase the maximum deflection angle. The depth of the CRT can be reduced in this way, leading to slimmer picture display devices.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The mere fact that certain measures are recited in mutually different dependent claims does not indicate that a combination of these measures cannot be used to advantage.

1. A picture display device comprising
a cathode ray tube (1) having an elongated display screen (8) with a long axis (21) and a short axis (22), a cone portion (3) whose cross-section has an elongated shape with a long axis and a short axis, a neck (4) comprising means (5) for generating at least one electron beam (6), and
a deflection system (9) mounted on said cone portion (3) for generating electromagnetic fields for deflecting said electron beam(s) (6),
characterized in that the deflection system (9) is arranged to scan the electron beam(s) (6) along lines substantially parallel to the short axis (22) of the display screen (8), and in that the part of the cone portion (3a) which is under the deflection system (9) has at least one cross-section whose internal outline has a long axis/short axis ratio (A_{c}) which is larger than or equal to the long axis/short axis ratio (A_{scr}) of the display screen (8).

2. A picture display device as claimed in claim 1, characterized in that the part of the cone portion (3a) which is under the deflection system (9) has at least one cross-section whose internal outline has a long axis/short axis ratio (A_{c}) which is larger than the long axis/short axis ratio (A_{scr}) of the display screen (8).

3. A picture display device as claimed in claim 2, characterized in that (A_{c}−1)/(A_{scr}−1)≧1.1 .

4. A picture display device as claimed in claim 2 or 3, characterized in that the part of the cone portion (3) between the reference deflection plane (11) and that end of the deflection system (9) which is nearest to the display screen (8) has a cross-section whose internal outline has a long axis/short axis ratio (A_{c}) which first increases, goes through a maximum and then decreases.

5. A picture display device as claimed in any one of claims 1 to 4, characterized in that A_{scr}>4/3.

6. A picture display device as claimed in claim 5, characterized in that A_{scr}≧16/9

7. A picture display device as claimed in any one of claims 1 to 6, characterized in that the maximum deflection angle of the electron beam(s) (6) is larger than or equal to 120°.
